(19) United States
(12) Patent Application Publication
(10) Pub. No.: US 2024/0135689 A1
(43) Pub. Date: Apr. 25, 2024

(54) SYSTEMS AND METHODS FOR ESTIMATING ROBUSTNESS OF A MACHINE LEARNING MODEL

(71) Applicant: Panasonic Intellectual Property Management Co., Ltd., Osaka (JP)

(72) Inventors: Yuya SUGASAWA, Osaka (JP); Hisaji MURATA, Osaka (JP); Nway Nway AUNG, Singapore (SG); Ariel BECK, Singapore (SG); Zong Sheng TANG, Singapore (SG)

(21) Appl. No.: 17/973,177

(22) Filed: Oct. 24, 2022

(51) Int. Cl. G06V 10/776

(52) U.S. Cl. CPC G06V 10/776

(57) ABSTRACT

According to an embodiment, a method for estimating robustness of a trained machine learning model is disclosed. The method comprises receiving a labelled dataset, a model of an object for which defect detection is required, and the trained machine learning model. Further, the method comprises determining one or more parameters associated with image capturing conditions in the environment. Furthermore, the method comprises performing an auto extraction of one or more defects using the model of the object and the labelled dataset based on image processing. Furthermore, the method comprises generating one or more images based on the one or more parameters and the one or more defects. Additionally, the method comprises testing the trained machine learning model using the generated images. Moreover, the method comprises estimating a robustness report for the machine learning model based on the testing of the machine learning model.

### FIELD OF THE INVENTION

The present invention generally relates to machine learning models, and more particularly relates to systems and methods for estimating robustness of machine learning models.

### BACKGROUND

Visual inspection systems must be highly accurate (i.e., able to differentiate OK and defective items). These requirements make such systems highly sensitive to working conditions and often not robust to changes. This can yield very high cost for factories as such change can occur slowly (dust accumulating on a conveyor belt) or promptly (i.e., camera out of position).

There is a need for a solution to address the aforementioned issues and challenges.

### SUMMARY

This summary is provided to introduce a selection of concepts, in a simplified format, that are further described in the detailed description of the invention. This summary is neither intended to identify key or essential inventive concepts of the invention and nor is it intended for determining the scope of the invention.

According to an embodiment of the present disclosure, a method for estimating robustness of a trained machine learning model is disclosed. The method comprises receiving a labelled dataset, a model of an object for which defect detection is required, and the trained machine learning model, wherein the trained machine learning model is used for identifying visual defects based on at least one image of the object captured in an environment around the object. Further, the method comprises determining one or more parameters associated with image capturing conditions in the environment. Furthermore, the method comprises performing an auto extraction of one or more defects using the model of the object and the labelled dataset based on image processing. Furthermore, the method comprises generating one or more images based on the one or more parameters associated with the imaging capturing conditions and the one or more defects applied on the model of the object. Additionally, the method comprises testing the trained machine learning model using the generated one or more images. Moreover, the method comprises estimating a robustness report for the machine learning model based on the testing of the machine learning model.

According to an embodiment of the present disclosure, a method for monitoring functionality of a trained machine learning model is disclosed. The method comprises receiving a labelled dataset, a model of an object for which defect detection is required, the trained machine learning model, and one or more captured images associated with possible failure of the trained machine learning model, wherein the trained machine learning model is used for identifying visual defects in the one or more captured images of the object captured in an environment. Further, the method comprises estimating changes in an output of the trained machine learning model and a distribution of features associated with the object based on the labelled dataset, the model of the object, and the one or more captured images. Furthermore, the method comprises determining one or more parameters associated with image capturing conditions in the environment. Furthermore, the method comprises generating one or more images based on the one or more parameters associated with the imaging capturing conditions and the model of the object. Additionally, the method comprises testing the trained machine learning model using the generated one or more images. Moreover, the method comprises providing a report associated with causes of the changes in the output of the trained machine learning model based on the testing of the machine learning model.

According to another embodiment of the present disclosure, a system for estimating robustness of a trained machine learning model is disclosed. The system comprises at least one processor configured to receive a labelled dataset, a model of an object for which defect detection is required, and the trained machine learning model, wherein the trained machine learning model is used for identifying visual defects based on at least one image of the object captured in an environment around the object. Further, the at least one processor is configured to determine one or more parameters associated with image capturing conditions in the environment. Furthermore, the at least one processor is configured to perform an auto extraction of one or more defects using the model of the object and the labelled dataset based on image processing. Additionally, the at least one processor is configured to generate one or more images based on the one or more parameters associated with the imaging capturing conditions and the one or more defects applied on the model of the object. Moreover, the at least one processor is configured to test the trained machine learning model using the generated one or more images. Still further, the at least one processor is configured to estimate a robustness report for the machine learning model based on the testing of the machine learning model.

According to another embodiment of the present disclosure, a system for monitoring functionality of a trained machine learning model is disclosed. The system comprises at least one processor configured to receive a labelled dataset, a model of an object for which defect detection is required, the trained machine learning model, and one or more captured images associated with possible failure of the trained machine learning model, wherein the trained machine learning model is used for identifying visual defects in the one or more captured images of the object captured in an environment. Further, the at least one processor is configured to estimate changes in an output of the trained machine learning model and a distribution of features associated with the object based on the labelled dataset, the model of the object, and the one or more captured images. Furthermore, the at least one processor is configured to determine one or more parameters associated with image capturing conditions in the environment. Additionally, the at least one processor is configured to generate one or more images based on the one or more parameters associated with the imaging capturing conditions and the model of the object. Moreover, the at least one processor is configured to test the trained machine learning model using the generated one or more images. Still further, the at least one processor is configured to provide a report associated with causes of the changes in the output of the trained machine learning model based on the testing of the machine learning model.

To further clarify the advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIGS. 1A and 1B illustrate an offline method and online testing method of a trained machine learning model's robustness during training and by monitoring the model's functioning during inference time, respectively, according to one or more embodiments of the present disclosure;

FIGS. 2A and 2B illustrate an exemplary process flow comprising an offline method 200 for estimating robustness of a trained machine learning model, according to an embodiment of the present disclosure;

FIGS. 3A, 3B, and 3C illustrate an exemplary process flow comprising an online method 300 for monitoring functionality of a trained machine learning model, according to an embodiment of the present disclosure;

FIG. 4 illustrates an exemplary process flow comprising a method 400 for a method for estimating changes or detecting a drift, according to an embodiment of the present disclosure;

FIG. 5 illustrates a process flow comprising a method for determining one or more camera intrinsic parameters, according to an embodiment of the present disclosure;

FIG. 6 illustrates a process flow depicting a method for performing defect extraction, according to an embodiment of the present disclosure;

FIGS. 7A and 7B illustrate another process flows comprising methods for performing defect extraction, according to an embodiment of the present disclosure;

FIG. 8 illustrates a process flow depicting a method for generating one or more images, according to an embodiment of the present disclosure;

FIG. 9 illustrates a process flow depicting a method for testing of a trained machine learning model, according to an embodiment of the present disclosure;

FIG. 10 illustrates a process flow depicting a method for estimating a break out point, according to an embodiment of the present disclosure;

FIG. 11 illustrates a schematic block diagram of a system for estimating robustness offline and to monitor functionality online of a trained machine learning model, according to an embodiment of the present invention; and

FIG. 12 illustrates a detailed view of the modules 1106 within a schematic block diagram of a system 1100 for estimating robustness and monitoring functionality of a trained machine learning model, according to an embodiment of the present disclosure; and

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION

For the purpose of promoting an understanding of the principles of the invention, reference will now be made to the various embodiments and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The present disclosure proposes to solve the above-mentioned issues by testing a trained machine learning model's robustness during training and by monitoring the model's functioning during inference time (“Health Checkup”).

According to one embodiment of the present disclosure, a proposed system and method based on a 3d model (e.g., CAD), a dataset and an A.I. (a trained machine learning) model is disclosed. The system and method is directed towards automatically testing the trained machine learning model's robustness by generating images in varying conditions including lighting, camera positions, dust on samples or on belts, defective flashes, etc. in an environment (e.g., a factory or a manufacturing line). Further, the present disclosure is directed towards outputting a report showing the model's weaknesses and behaviour when confronted with such changes. The present disclosure is directed towards offline (pre-deployment) stage and the online (post-deployment) stage of the trained machine learning model.

For online model performance monitoring and analysis, the system and method utilize a fully virtual inspection system updated in real time in order to predict model's failure before they occur. It monitors whether the line and models are ‘healthy’ and is able to predict prediction failures by monitoring the input data and trends and use synthetic data to test.

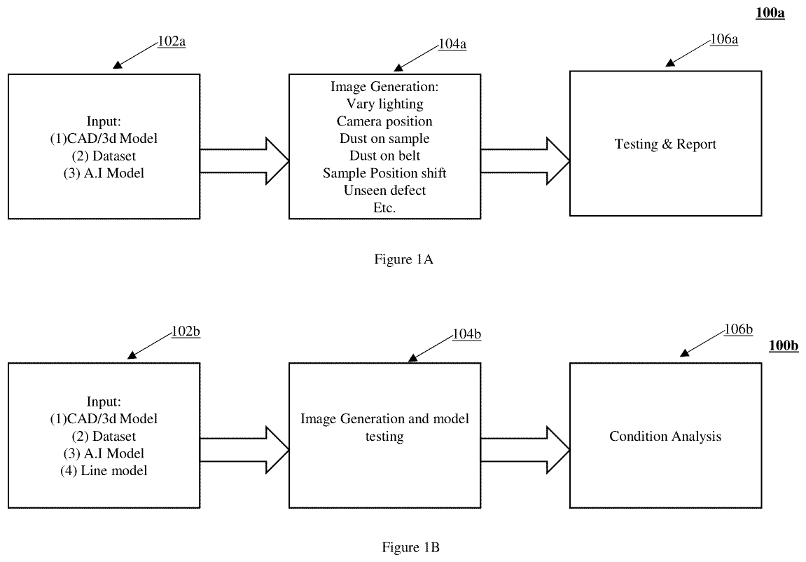

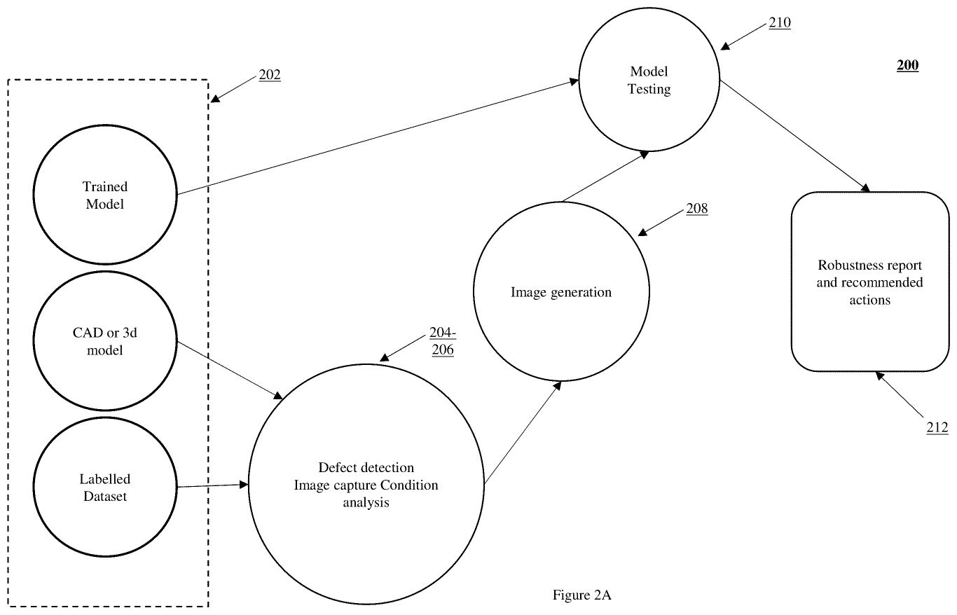

FIGS. 1A and 1B illustrate an offline method 100a and online testing method 100b of a trained machine learning model's robustness during training and by monitoring the model's functioning during inference time, respectively, according to one or more embodiments of the present disclosure.

Referring to FIG. 1A, a method 100a to test/assess a trained machine learning model's offline robustness is disclosed. Specifically, the method 100a at step 102a includes receiving a 3D model (e.g., CAD), a labelled dataset of images, and an A.I. (a trained machine learning) model as an input for automatically testing the trained machine learning model's robustness. At step 104a, the method 100a comprises generating images in varying conditions including lighting, camera positions, dust on samples or on belts, defective flashes, etc. in an environment (e.g., a factory or a manufacturing line). Further, at step 106a, the method 100a comprises testing the trained machine learning model based on the generated images and providing a report associated with robustness of the model. The robustness may imply whether the model is able to perform appropriately (i.e., in a desired manner) upon encountering one or more environmental hazardous or faulty conditions associated with functioning of the model. The environmental hazardous or fault conditions may include, but not limited to, dust, sensor breakage, etc. The report may indicate the model's weaknesses and behaviour when confronted with such changes.

Referring to FIG. 1B, a post deployment (i.e., online) behaviour of the trained machine learning model may be assessed. For online model performance monitoring and analysis, the system and method utilize a fully virtual inspection system updated in real time in order to predict model's failure before they occur. At step 102b, the method 100b comprises receiving a 3D model (e.g., CAD), a labelled dataset of images, an A.I. (a trained machine learning) model, and a line model comprising one or more capture images as an input for automatically testing the trained machine learning model's robustness. At step 104b, the method 100b comprises generation of one or more new images based on a drift detected in received/captured images, and testing of the deployed model based on the new generated images. This is explained in conjunction with detailed figures later. At step 106b, the method 100b comprises providing a condition analysis including a report similar to step 106a. Thus, the method 100b comprises monitoring whether the line and models are ‘healthy’ and is able to predict prediction failures by monitoring the input data and trends and use synthetic data to test.

Thus, the present disclosure provides for a method to regularly check health for visual inspection systems comprising a machine learning model for detecting defected images clicked by a camera in a manufacturing line.

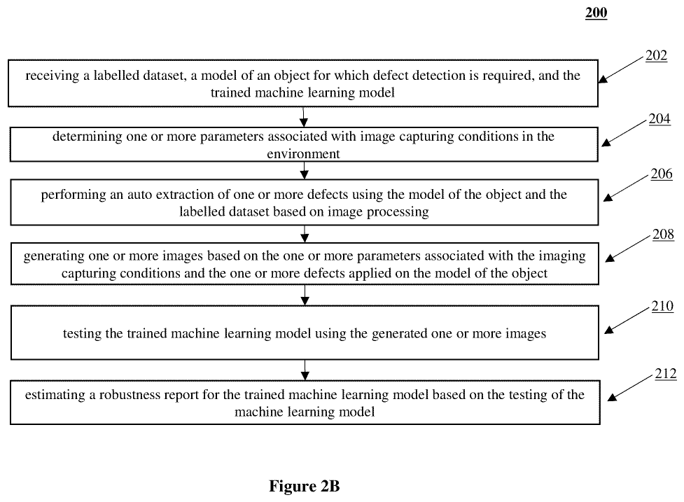

FIGS. 2A and 2B illustrate an exemplary process flow comprising an offline method 200 for estimating robustness of a trained machine learning model, according to an embodiment of the present disclosure. For the sake of brevity, details of the present disclosure that are explained in detail in the description of FIG. 1 are not explained in detail in the description of FIGS. 2A and 2B.

At step 202, the method 200 comprises receiving a labelled dataset, a model of an object for which defect detection is required, and the trained machine learning model.

In an embodiment, the labelled dataset may include a dataset that is labelled by a domain expert user (e.g., a factory engineer). The labelling process for the dataset may include marking the images as NG (defect images) and OK (non-defect images). For example, in the context of detecting the presence of scratch on a sample object, a particular image with a scratch will be marked as NG, while a non-scratch image will be marked as an OK image. In an embodiment, the labelled dataset may include defect segmentation, which facilitates in extraction of defects in an easy manner.

In an embodiment, the model of the object may be a CAD Model or a 3D Model created in a 3D Simulation tool/software. The model of the object may be created for an object for which defect detection is required.

In one embodiment, the trained machine learning model (e.g., a neural network) may be used for identifying visual defects based on at least one image of the object captured in an environment around the object. In the above exemplary embodiment associated with the input labelled dataset related to scratch images, the trained machine learning model may be configured to identify NG and OK images. The trained machine learning model may include, but not limited to, a deep learning model, and a random forest model.

At step 204, the method 200 comprises determining one or more parameters associated with image capturing conditions in the environment. In one embodiment, the one or more parameters may comprise, but not limited to, camera intrinsic parameters, lighting, and object position. The camera intrinsic parameters may include at least one of fstop, number of aperture blades, focal length and lens distortion parameters.

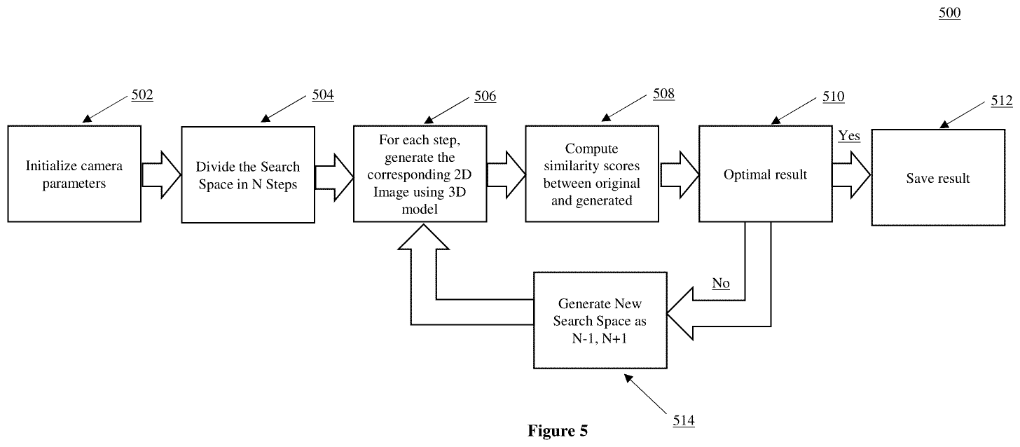

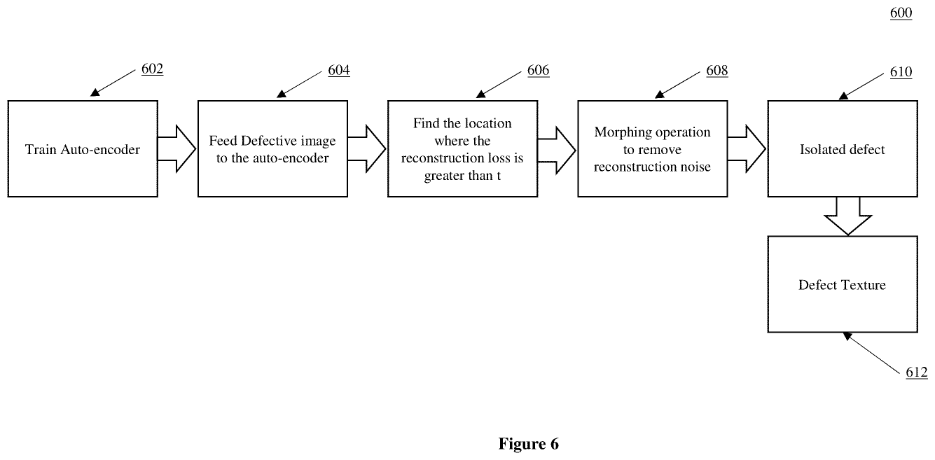

In an embodiment, the camera intrinsic parameters may be predefined and/or may be obtained from the operator or inferred from one of the images associated with the camera (e.g., sensor size, resolution, etc.). In another embodiment where the camera intrinsic parameters may not be predefined or may not be inferred, a step-by-step methodology may be used, as depicted in FIG. 5.

Referring to FIG. 5, a process flow 500 is depicted for determining one or more camera intrinsic parameters, such as, but not limited to, fstop, number of aperture blades, focal length, and lens distortion parameters. Specifically, the process flow 500 corresponds to searching for a set of camera intrinsic parameters that can generate the most similar image to the camera with such specific parameters. Thus, this is an estimation of camera intrinsic parameters under the assumption that such parameters are capable to map to the actual parameters of the camera.

Specifically, determining the one or more camera intrinsic parameters comprises steps 502-514. At step 502, one or more camera parameters may be initialized. In an exemplary embodiment, the initialized camera intrinsic parameters may include fstop, number of aperture blades, focal length, and lens distortion parameters.

At step 504, a search space associated with one or more parameters may be divided into a predefined number of steps (e.g., 10). The search space may include a set of all possible values associated with camera parameters within a pre-defined range and constraints. For example, the initialized camera parameters and their associated ranges may include:
a) fstop: f/2.8, f/4, f/5.6, step=half stop
b) number of aperture blades: range from 3 to 14, step=1
c) focal length: range from 18 to 90 mm, step=2 mm
d) lens distortion: range from −0.014 to 0.0188, step=0.001

Thus, search space N may be defined as:
a) param 1=>range of param 1/step of param 1=>TotalSearchSpace 1
b) param 2=>range of param 2/step of param 2=>TotalSearchSpace 2
c) param 3=>range of param 3/step of param 3=>TotalSearchSpace 3
d) param 4=>range of param 4/step of param 4=>TotalSearchSpace 4

Total N=TotalSearchSpace1*TotalSearchSpace2*TotalSearchSpace3*TotalSearchSpace4
For example, total search space for param3: 18 to 55 mm, step=2 mm
   18,20,22,24 . . . , 48,52,54=>19

Subsequently, at steps 506-508, for each step of the predefined number of steps, one or more 2D image of the model of object may be generated to calculate a similarity score between the OK (non-defect) images from the labelled dataset and the generated 2D images. The 2D image may be generated using a CAD model or a 3D simulation software along with using a 3D dataset. In an embodiment, the 3D simulation software may have a viewpoint rendering feature, which may use a Python script to render 2D images from 3D model of the object. In an exemplary embodiment, the examples of images may include factory products, such as, but not limited to, battery, capacitor, and circuit board. In an example, the optima shall be between 2 steps. At step 510, it may be determined whether the result is optimal or not, i.e., whether the similarity score is within a predefined threshold range. In case the similarity score is within the predefined threshold range, then the parameters may be saved at step 512. If the similarity score is not within the predefined threshold range, a new search space may be created at step 514. For example, the new search space may correspond to N+1, N−1, which is searching in between N+1 and N−1 using smaller step(s), and the steps of generating (506), computing similarity score (508), and determination of similarity score within the threshold (510) may then be repeated. In an exemplary embodiment, SSIM, MMD, KL-divergence and Wasserstein will be used as evaluation metrics for determining similarity scores.

Accordingly, to summarize the above process 500, a range of camera intrinsic parameters in the simulated camera are defined, and one or more 2D images of object(s) are generated from the CAD or 3D model. If the similarity score between the OK images and generated 2D images is high, then it may be concluded that the generated image(s) are similar to the OK image(s) from the labelled dataset. Hence, the corresponding camera intrinsic parameters are presumably correct, and thus, these parameters are saved at step 512.

Referring back to FIGS. 2A and 2B, at step 206, the method 200 comprises performing an auto extraction of one or more defects using the model of the object and the labelled dataset based on image processing. Additionally, one or more defective samples may be provided as an input as this step 206. The auto-extraction of one or more defects may include segmenting the defect location on the defective sample(s) being provided as an input. In one embodiment, performing the auto extraction of defective parts is based on subtracting a median image computed based on one or more samples from the labelled dataset selection to isolate the defect. The one or more samples may be OK samples (e.g., images) from the labelled dataset.

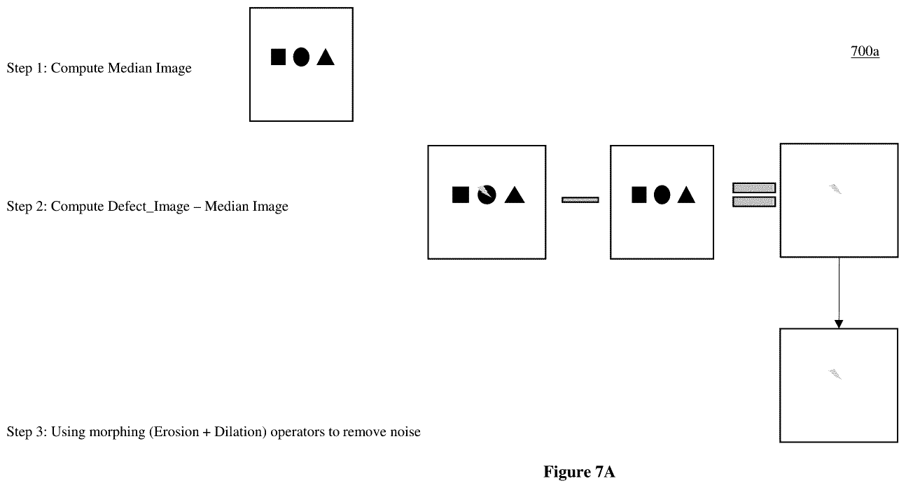

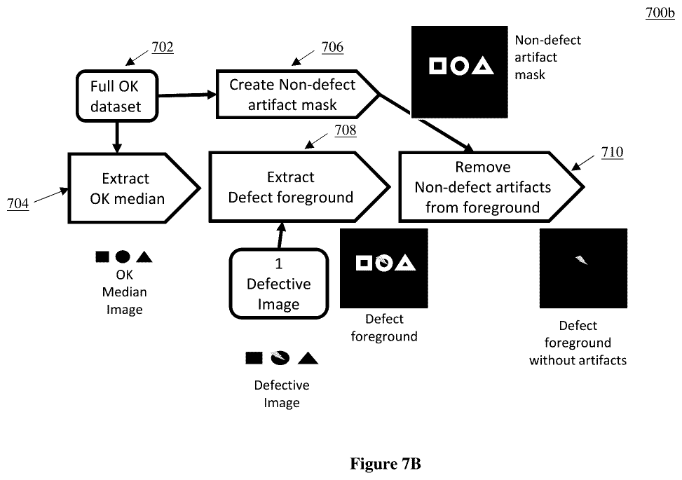

More specifically, the defect extraction may be performed based on number of defect samples provided as an input. If the number of defect samples are more than a predefined threshold number of samples, then the process 600 depicted in FIG. 6 may be performed for defect extraction. Otherwise, the process 700a and 700b depicted in FIGS. 7A and 7B respectively may be performed for defect extraction.

Referring to FIG. 6, the process 600 of defect extraction comprises steps 602-612. At step 602, an auto-encoder associated with the trained machine learning model may be trained with the defect samples. The auto encoder may be an unsupervised model which may be used to extract the defect sample(s). The output/result of the auto encoder may be used by the trained model. At step 604, a defective image may be fed into the auto-encoder. At step 606, the process 600 comprises finding the location where the reconstruction loss is greater than a predefined value “t”. The threshold value may be pre-defined and adjustable based on user requirement to get finer/coarser extraction. At step 608, a morphing operation to remove reconstruction noise may be performed. At step 610, the defect may be isolated. At step 612, the defect texture may be provided as an output.

Referring to FIG. 7A, an illustration 700a of extracting defect when defect samples are below a threshold is depicted. At step 1, a median image may be computed. At step 2, a defect median image may be determined. At step 3, morphing (Erosion+Dilation) operators may be used to remove noise.

Referring to FIG. 7B, a detailed illustration 700b of extracting defect when defect samples are below a threshold is depicted. This process is related to augmentation of defect class in the dataset. This process of augmentation of defect class has been discussed in detail in U.S. application Ser. No. 17/173,822 assigned to Panasonic Intellectual Property Management Co., Ltd., the content of which are incorporated herein in its entirety.

At step 702, the process 700b comprises preparing a full OK dataset (i.e., images of OK products). OK dataset is a human verified set of images that contain no defect.

At step 704, the process 700b comprises extracting the median image from the OK dataset. In an embodiment, the median image may be generated based on a pixelwise median approach, which is the operation of calculating the median intensity occurring at the corresponding pixel across the entire dataset. In other words, an OK median image is the image obtained by pixelwise median operation on the entire OK dataset.

More specifically, generating a median image corresponding to the set of images associated with the first class. In one embodiment, generating the median image comprises calculating, for each pixel of the median image, a median intensity occurring at the corresponding pixel across the set of images associated with the majority class of images. Subsequently, the median image is generated based on the calculated median intensity for each pixel of the set of images associated with the majority class of images.

At step 706, the process 700b comprises creating a non-defect artifact mask. In one embodiment, the non-defect artifact mask may be created by a pixelwise subtraction approach, which is the operation of calculating the difference of intensity occurring at the corresponding pixel across the 2 images. Non-defect artifact mask is a way to locate areas in the foreground which might capture some artifacts (like edge) of the image which are not true defect. More specifically, in an embodiment, the non-defect artifact mask may be created based on a difference of intensity occurring at each pixel between the median image and the set of images associated with the first class. The non-defect artifact mask is a visible feature in the foreground that are not defects. These may arise out of edges and texture differences in the image.

At step 708, the process 700b comprises extracting a defect foreground. Defect Foreground is the product of removing the background (OK median image) from the defective image by pixelwise subtraction. This contains the defect and a few non-defect artifacts like edges. In an embodiment, the defect foreground may be extracted based on the median image and each defect image of the set of images associated with the second (defect/minority) class. The defect foreground is a visible feature identifying a defect present in the foreground.

At step 710, the process 700b comprises removing non-defect artifacts from defect foreground to obtain defect foreground without artifacts. Specifically, the defect foreground without artifacts is obtained by subtracting the non-defect mask areas.

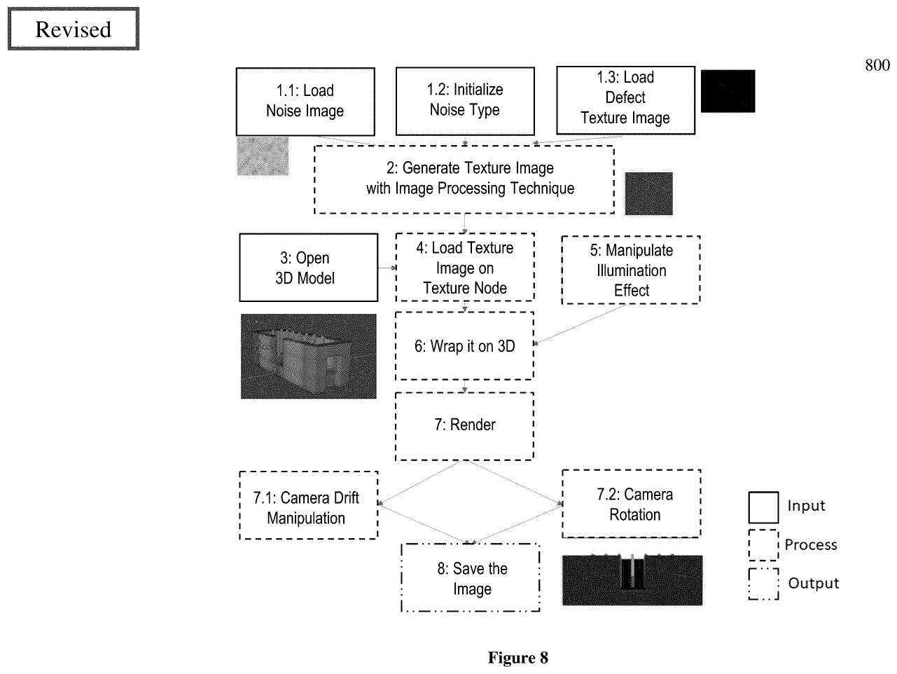

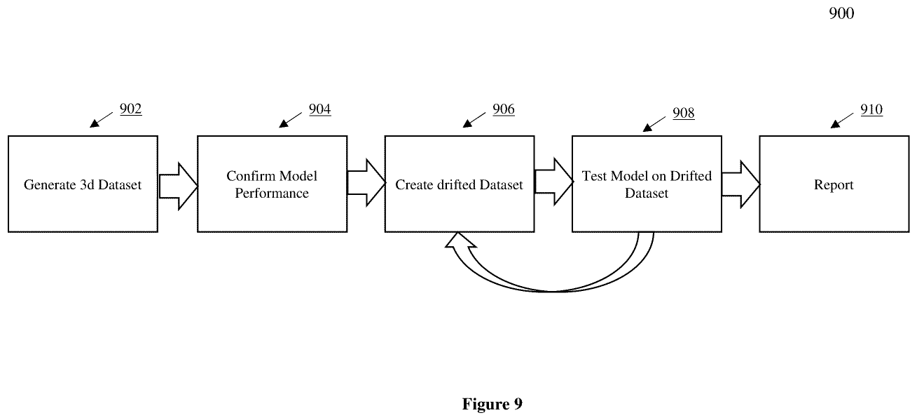

Referring back to FIGS. 2A and 2B, at step 208, the method 200 comprises generating one or more images based on the one or more parameters associated with the imaging capturing conditions and the one or more defects applied on the model of the object. In one embodiment, the generating comprises generating the one or more images in varying conditions including associated with at least one of lighting, camera positions, dust particles, and defective flashes. Accordingly, the new generated images may be similar to the real-world images. The method of generating such one or more images is discussed in conjunction with FIG. 8.

Referring to FIG. 8, a process flow comprising a method 800 of generating one or more images based on the one or more parameters associated with the imaging capturing conditions and the one or more defects applied on the model of the object is depicted.

At step 1, the method 800 comprises initializing and providing as an input the extracted one or more defects, a noise image, and a noise type. Accordingly, the defect texture image from step 206, a pre-stored noise image, and the noise type (e.g., white Noise: Gaussian and/or salt and pepper noise) may be loaded or input. As is generally known, noise is a chaotic or patterned signal that is captured during photography which can be the result of multiple sources, such as, a random fluctuation of the air density causing small fluctuation of the light path, the spontaneous process of electron fired from the camera sensor due to the energy fluctuation, etc.

At step 2, the method 800 comprises adding noise type and/or noise image to the defect texture image using image processing techniques to generate a texture image.

At step 3, the method 800 comprises opening the 3D Model of the object.

At step 4, the method 800 comprises loading the texture image and adding the image to a texture node. The texture node may be a model node that defines the texture of the computer simulated object (i.e., the object as discussed above), where it may be determined (e.g., using a mathematical equation) how to diffract/reflect/diffuse the incoming light to the camera.

At step 5, the method 800 comprises manipulating an illumination effect of the incoming light in the environment around the object/camera. The illumination effect is the simulation of the light sources to the object where the light can be modeled as a diffracted source, parallel light, light beam with different beam profile and different luminance.

At step 6, the method 800 comprises wrapping the illumination effect on the 3D model of the object or the texture node.

At step 7, the method 800 comprises manipulating the camera drift and viewpoint angle and rendering the image. The view point is the location where the simulated sensor/camera is located. The function of the view point is to provide a target for the illuminated light to interact with the camera or the simulated sensor.

At step 8, the method 800 comprises saving the images to be used in the inspection process or the process to determine robustness of the trained machine learning model.

Thus, the images generated based on the variations are similar to the real dataset.

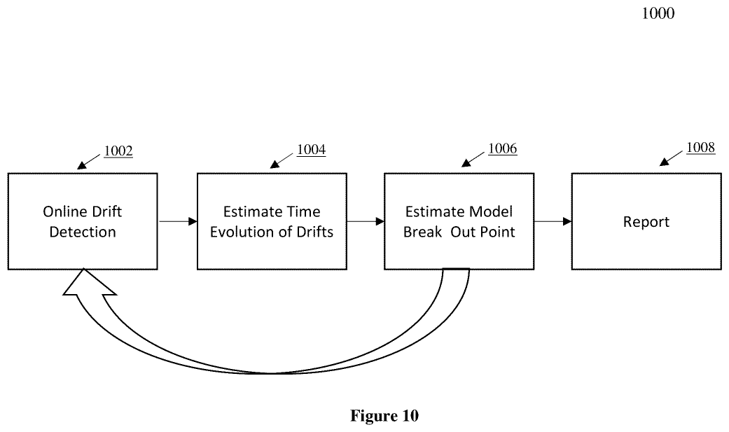

Referring back to FIG. 2B, at step 210, the method 200 comprises testing the trained machine learning model using the generated one or more images. In an embodiment, testing the machine learning model comprises determining a confidence score of the machine learning model based on testing of the machine learning model using the generated one or more images. Further, it may be determined whether the confidence score is below a predefined threshold indicating a robustness of the machine learning model. In response to determining that the confidence score is below the predefined threshold, the machine learning model may be re-tested based on a drifted version of the one or more images, wherein the drifted version is created by varying one or more parameters of the images. The testing of trained machine learning model is explained in conjunction with FIG. 9.

Referring to FIG. 9, a process flow depicting a method 900 for testing of the trained machine learning model is depicted. At step 902, the method 900 comprises generating a full 3D dataset of one or more 2D images as explained earlier in step 208 similar to the real dataset of images that may be captured in a real environment. The images in step 902 may be generated based on one or more predefined baseline camera intrinsic parameters.

At step 904, the method 900 comprises confirming performance of the trained machine learning model on the generated 3D dataset of images, which is expected to be on par with real dataset.

At step 906, the method 900 comprises creating a new 3D dataset to define the robustness by manipulating the brightness, camera position, noise (simulating dust), etc. Specifically, the one or more baseline camera intrinsic parameters may be modified/changed to generate a new 3D dataset. The new 3D dataset is the drifted data set where the camera parameters are different with the baseline parameters. All the images created using non baseline parameter are considered as drifted data.

At step 908, the method 900 comprises testing the trained machine learning model and increase the “drift” until a breakup point is found. When the deviation/drift of the baseline parameters is small, the trained machine learning model may still be capable enough to differentiate OK and defect sample images. However, there exists a point where changes are significant enough which the trained machine learning model cannot predict with a reasonable accuracy, and this point may be considered as a breaking point The confidence score of the trained machine learning model may be used as a threshold to determine the “drift” of the dataset. For instance, for a threshold of 0.5, anything less than that considers triggering the “Drift” and will be defined as a “Breakup Point”.

At step 904, the method 900 comprises reporting based on how robust the model is and how far is the break-up point in the various categories.

Referring back to FIGS. 2A and 2B, in an embodiment, at step 210, the method 200 may include determining, using the machine learning model, an amount of noise in an analysis of the one or more images during testing of the machine learning model, wherein the amount of noise is indicative of the noise present in an environment around the object.

At step 212, the method 200 comprises estimating a robustness report for the trained machine learning model based on the testing of the machine learning model. The robustness report may include a robustness score indicating accuracy of the trained machine learning model in identifying defects in the objects. A high robustness score may correspond to the real-world images generated at step 208. In other words, the machine learning model may detect defects with highest accuracy on synthetic 3D dataset of images (which are similar to real-world images). An exemplary sample report comprising category of robustness and corresponding model performance is indicated in Table 1 below:

TABLE 1

| | Model |
|---|---|
| Category | Performance |
| Robustness to Dust | 0-100 |
| Robustness to Sensor | 0-100 |
| breakage | |
| Robustness to shift in | 0-100 |
| camera position | |
| Robustness to drift in | 0-100 |
| lighting condition | |
| . . . | |

Here, in the above exemplary table, in the context of dusty, a value of 0-20 may signify a clean state, 20-50 may signify a mild dusty state, 50-70 may signify a moderate dusty state, 70-100 may signify a severe dusty state.

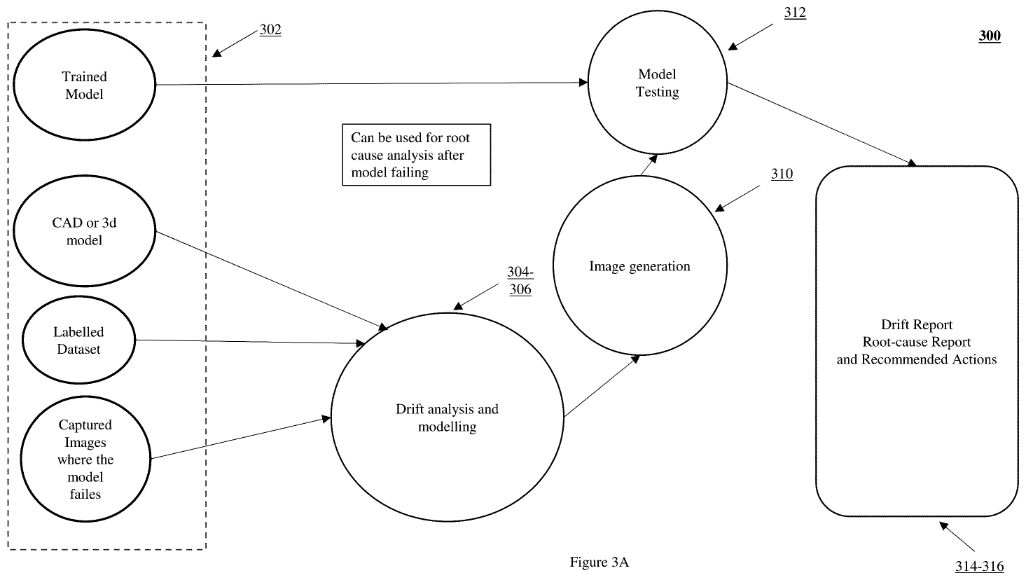

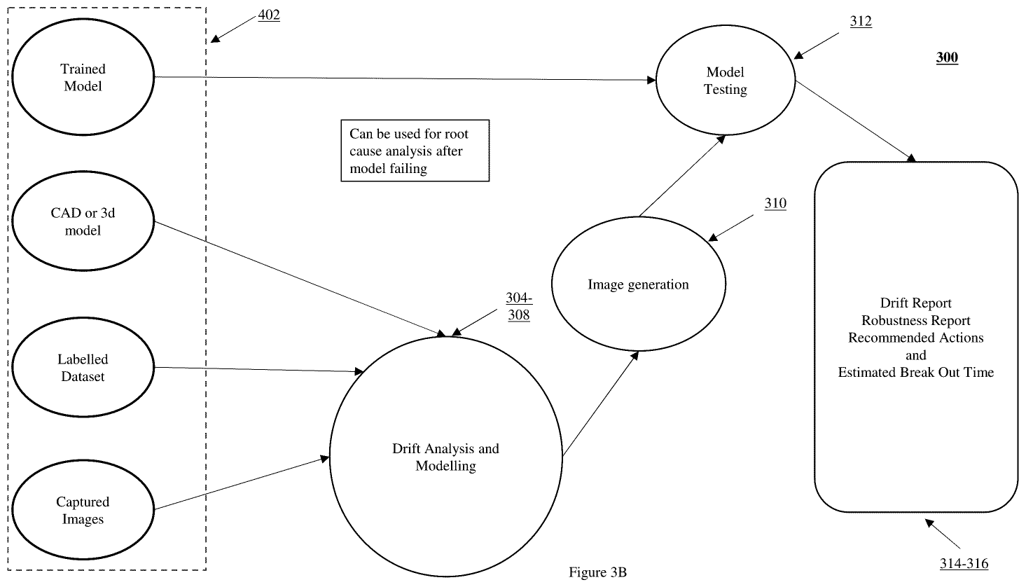

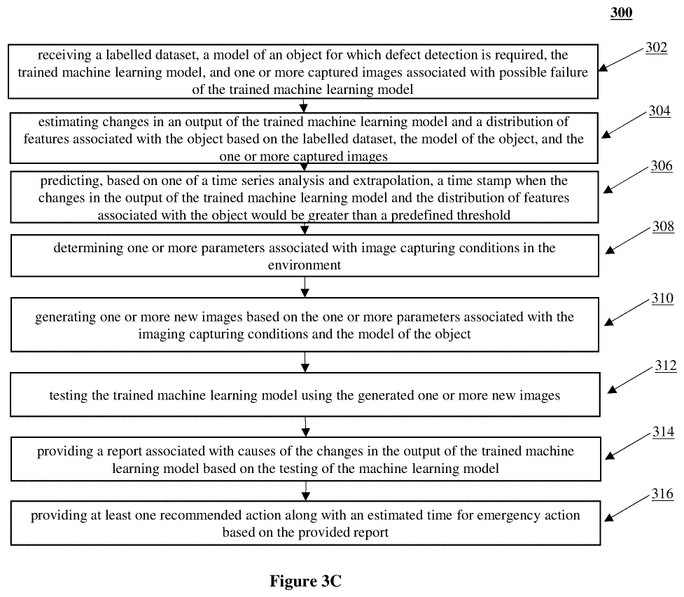

FIGS. 3A, 3B, and 3C illustrate an exemplary process flow comprising an online method 300 for monitoring functionality of a trained machine learning model, according to an embodiment of the present disclosure. For the sake of brevity, details of the present disclosure that are explained in detail in the description of FIGS. 1, and 2A-2B are not explained in detail in the description of FIGS. 3A, 3B, and 3C. While FIG. 3A describes providing a root cause analysis for post deployment failure scenario of the trained machine learning model, FIG. 3B describes providing a root cause analysis and an estimated break out time for post deployment failure scenario of the trained machine learning model. FIG. 3C provides a method/flowchart based on FIGS. 3A and 3B.

At step 302, the method 300 comprises receiving a labelled dataset, a model of an object for which defect detection is required, the trained machine learning model, and one or more captured images associated with possible failure of the trained machine learning model. In one embodiment, the trained machine learning model may be used for identifying visual defects in the one or more captured images of the object captured in an environment.

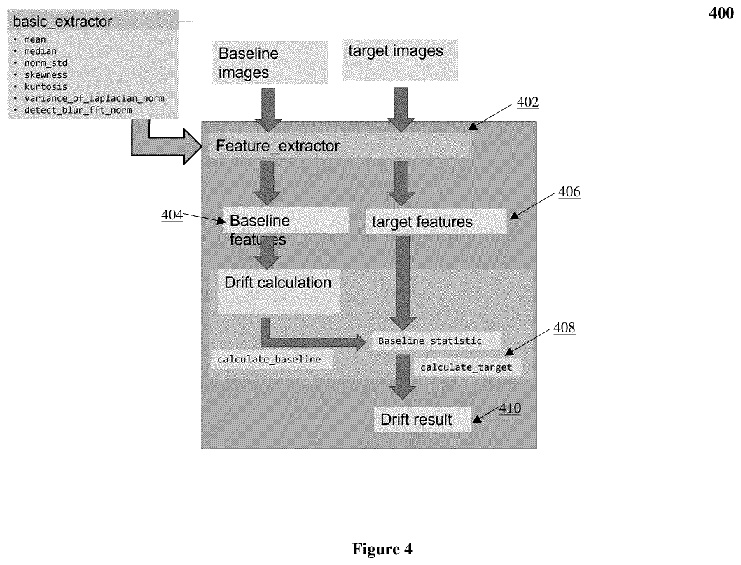

At step 304, the method 300 comprises estimating changes in an output of the trained machine learning model and a distribution of features associated with the object based on the labelled dataset, the model of the object, and the one or more captured images. In one embodiment, the one or more captured images may be related to images where the trained machine learning model fails. The methodology of estimating the changes is discussed in conjunction with FIG. 4.

At step 306, the method 300 comprises predicting, based on one of a time series analysis and extrapolation, a time stamp when the changes in the output of the trained machine learning model and the distribution of features associated with the object would be greater than a predefined threshold. In other words, at step 306, it may be predicted at what time will the deviation in features will exceed a point of maximum toleration (i.e., threshold).

At step 308, the method 300 comprises determining one or more parameters associated with image capturing conditions in the environment. The parameters may correspond to one or more drifted parameters detected based on the received one or more captured images. In one embodiment, a machine learning model may be trained to output the image capturing conditions for the received/captured images based on the 3D modelled dataset (i.e., labelled dataset received at step 302). For example, the output of the trained machine learning model based on the input captured/received image may include an estimation of the lens parameters (focal length and aperture) and/or imaging capture condition. In this embodiment, the parameters search described in steps 308 are replaced by this ML model.

At step 310, the method 300 comprises generating one or more new images based on the one or more parameters associated with the imaging capturing conditions and the model of the object. Specifically, the trained machine learning model may generate one or more new images based on the drifted parameters. In other words, the new images shall have the same drift as the input captured/received images at step 302.

At step 312, the method 300 comprises testing the trained machine learning model using the generated one or more new images. The newly generated data will go through the trained machine learning model to recreate the same model output distribution. As an example, the model predicting a received data as OK with a confidence level of 90%, and the newly generated data should have a similar distribution (˜90%). The generated images are considered fail, if the prediction confidence is vastly different (e.g., 10%). The testing may be performed in a manner similar to as described in step 210. Thus, for the sake of brevity, this is not discussed here in detail.

At step 314, the method 300 comprises providing a report associated with causes of the changes in the output of the trained machine learning model based on the testing of the machine learning model. In one embodiment, providing the report may comprise the predicted time stamp when the changes would be greater than the predefined threshold, as determined in step 406.

At step 316, the method 300 comprises providing at least one recommended action along with an estimated time for emergency action based on the provided report, wherein the at least one recommended action comprises one or more of modifying at least one parameter associated with the camera, modifying at least one parameter associated with fixing the lighting in the environment, and re-training the trained machine learning model. An exemplary sample report comprising category of robustness, a corresponding model performance, and recommended action(s) is indicated in Table 2 below:

TABLE 2

| | Model | Recommended |
|---|---|---|
| Category | Performance | Action |
| Issue with dust | 0-100 | Clean up conveyor |
| on factory line | | belt |
| Flash Failure | 0-100 | Replace camera |
| | | flashes |
| Camera position | 0-100 | Shift 5 degree to the |
| | | left |
| . . . | | |

Further, an exemplary sample report comprising category of robustness, a corresponding model performance, recommended action(s), and estimated emergency time is indicated in Table 3 below:

TABLE 3

| | Model | Recommended | Estimated |
|---|---|---|---|
| Category | Performance | Action | Emergency action |
| Issue with | 0-100 | Clean up | 3 Days |
| dust on | | conveyor | |
| factory line | | belt | |
| Flash | 0-100 | Replace | Immediate |
| failure | | camera | |
| | | flashes | |
| Dead pixel | | Replace | Immediate |
| | | sensor | |
| Camera | 0-100 | Shift 5 | Immediate |
| position | | degree to | |
| | | the left | |
| Dust on | 0-100 | Sensor | 10 days |
| camera | | clean-up | |
| sensor | | | |

FIG. 4 illustrates an exemplary process flow comprising a method 400 for a method for estimating changes or detecting a drift, according to an embodiment of the present disclosure.

At step 402, the method 400 comprises extracting the features from the generated one or more images.

At step 404, the method 400 comprises calculating the distribution of the features of the generated one or more images; The generated data set with the optimal parameter is baseline.

At step 406, the method 400 comprises calculating one or more target features from one or more target images; The generated data with drifted parameter corresponds to ‘target’ images.

At step 408, the method 400 comprises calculating a target distribution of the target features;

At step 410, the method 400 comprises comparing the target distribution with respect to the distribution to calculate the changes.

While the above steps are shown in FIGS. 2B, 3C, and 4 and described in a particular sequence, the steps may occur in variations to the sequence in accordance with various embodiments of the present disclosure. Further, the details related to various steps of FIGS. 2B, 3C, and 4 which are already covered in the description related to FIGS. 1A and 1B are not discussed again in detail here for the sake of brevity.

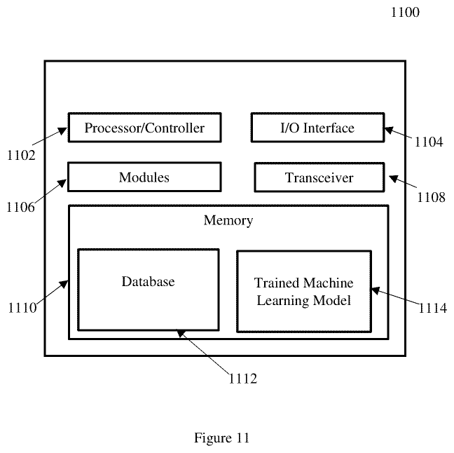

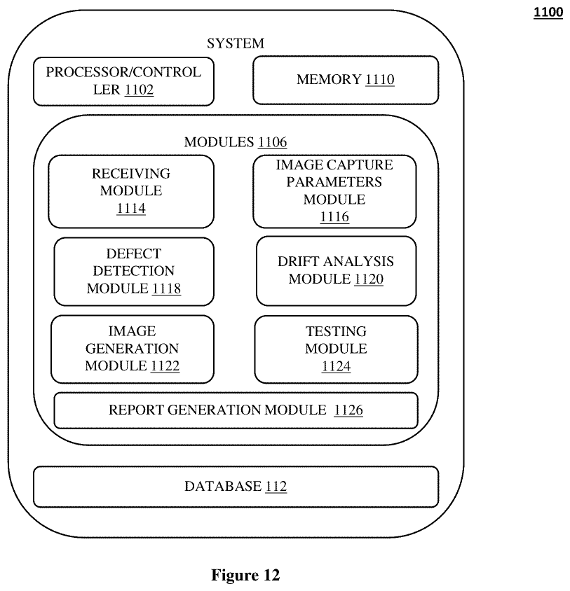

FIG. 11 illustrates a schematic block diagram of a system 1100 for estimating robustness offline and to monitor functionality online of a trained machine learning model, according to an embodiment of the present invention. In one embodiment, the system 1100 may be used to implement the various methods discussed above with reference to FIGS. 1A-1B, 2A-2B, 3A-3C, and 4-10.

In one embodiment, the system 1100 may be included within a mobile device or a server (e.g., a cloud based server). The system 1100 may be used for both offline robustness estimation as well as online monitoring functionality of the trained machine learning model. Examples of mobile device may include, but not limited to, a laptop, smart phone, a tablet, or any electronic device having a capability to access internet and to install a software application(s). The system 1100 may further include a processor/controller 1102, an I/O interface 1104, modules 1106, transceiver 1108, and a memory 1110.

In some embodiments, the memory 1110 may be communicatively coupled to the at least one processor/controller 1102. The memory 1110 may be configured to store data, instructions executable by the at least one processor/controller 1102. In one embodiment, the memory 1110 may include the trained machine learning model 1114, as discussed throughout the disclosure. In another embodiment, the trained machine learning model 1114 may be stored on a cloud network or a server which is to be tested for robustness and function.

In some embodiments, the modules 1106 may be included within the memory 1110. The memory 1110 may further include a database 1112 to store data. The one or more modules 1106 may include a set of instructions that may be executed to cause the system 1100 to perform any one or more of the methods disclosed herein. The one or more modules 1106 may be configured to perform the steps of the present disclosure using the data stored in the database 1112, to perform forecasting of a fluctuating timeseries, as discussed throughout this disclosure. In an embodiment, each of the one or more modules 1106 may be a hardware unit which may be outside the memory 1110. The transceiver 1108 may be capable of receiving and transmitting signals to and from system 1100. The I/O interface 1104 may include a display interface configured to receive user inputs and display output of the system 1100 for the user(s). Specifically, the I/O interface 1104 may provide a display function and one or more physical buttons on the system 1100 to input/output various functions, as discussed herein. Other forms of input/output such as by voice, gesture, signals, etc. are well within the scope of the present invention. In one embodiment, the I/O interface 1104 may receive dataset, CAD/3D model of an object, images captured from camera in a surrounding environment, etc. as discussed throughout this disclosure. For the sake of brevity, the architecture and standard operations of memory 1110, database 1112, processor/controller 1102, transceiver 1108, and I/O interface 1104 are not discussed in detail. In one embodiment, the database 1112 may be configured to store the information as required by the one or more modules 1106 and processor/controller 1102 to perform one or more functions to forecast a fluctuating timeseries.

In one embodiment, the memory 1110 may communicate via a bus within the system 1100. The memory 1110 may include, but not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory 1110 may include a cache or random-access memory for the processor/controller 1102. In alternative examples, the memory 1110 is separate from the processor/controller 1102, such as a cache memory of a processor, the system memory, or other memory. The memory 1110 may be an external storage device or database for storing data. The memory 1110 may be operable to store instructions executable by the processor/controller 1102. The functions, acts or tasks illustrated in the figures or described may be performed by the programmed processor/controller 1102 for executing the instructions stored in the memory 1110. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing, and the like.

Further, the present invention contemplates a computer-readable medium that includes instructions or receives and executes instructions responsive to a propagated signal, so that a device connected to a network may communicate voice, video, audio, images, or any other data over a network. Further, the instructions may be transmitted or received over the network via a communication port or interface or using a bus (not shown). The communication port or interface may be a part of the processor/controller 1102 or maybe a separate component. The communication port may be created in software or maybe a physical connection in hardware. The communication port may be configured to connect with a network, external media, the display, or any other components in system, or combinations thereof. The connection with the network may be a physical connection, such as a wired Ethernet connection or may be established wirelessly. Likewise, the additional connections with other components of the system 1100 may be physical or may be established wirelessly. The network may alternatively be directly connected to the bus.

In one embodiment, the processor/controller 1102 may include at least one data processor for executing processes in Virtual Storage Area Network. The processor/controller 1102 may include specialized processing units such as, integrated system (bus) controllers, memory management control units, floating point units, graphics processing units, digital signal processing units, etc. In one embodiment, the processor/controller 1102 may include a central processing unit (CPU), a graphics processing unit (GPU), or both. The processor/controller 1102 may be one or more general processors, digital signal processors, application-specific integrated circuits, field-programmable gate arrays, servers, networks, digital circuits, analog circuits, combinations thereof, or other now known or later developed devices for analyzing and processing data. The processor/controller 1102 may implement a software program, such as code generated manually (i.e., programmed).

The processor/controller 1102 may be disposed in communication with one or more input/output (I/O) devices via the I/O interface 1104. The I/O interface 1104 may employ communication code-division multiple access (CDMA), high-speed packet access (HSPA+), global system for mobile communications (GSM), long-term evolution (LTE), WiMax, or the like, etc.

The processor/controller 102 may be disposed in communication with a communication network via a network interface. The network interface may be the I/O interface 1104. The network interface may connect to a communication network. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network may include, without limitation, a direct interconnection, local area network (LAN), wide area network (WAN), wireless network (e.g., using Wireless Application Protocol), the Internet, etc. The network interface may employ connection protocols including, but not limited to, direct connect, Ethernet (e.g., twisted pair 10/100/1000 Base T), transmission control protocol/internet protocol (TCP/IP), token ring, IEEE 802.11a/b/g/n/x, etc.

FIG. 12 illustrates a detailed view of the modules 1106 within a schematic block diagram of a system 1100 for estimating robustness and monitoring functionality of a trained machine learning model, according to an embodiment of the present disclosure. As illustrated, in one embodiment, the one or more modules 1106 may include a receiving module 1114, an image capture parameters module 1116, a defect detection module 1118, a drift analysis module 1120, an image generation module 1122, a testing module 1124, and a report generation module 1126.

In one embodiment, a receiving module 1114 may be configured to receive one or more of a labelled dataset, a model of an object for which defect detection is required, the trained machine learning model, and one or more captured images associated with possible failure of the trained machine learning model. The receiving module may be configured to perform the steps discussed above in conjunction with step 202 and/or 302.

In one embodiment, the image capture parameters module 1116 may be configured to determining one or more parameters associated with image capturing conditions in the environment as discussed previously in conjunction with step 204 and/or 308.

In one embodiment, the defect detection module 1118 may be configured to performing an auto extraction of one or more defects using the model of the object and the labelled dataset based on image processing. Specifically, the defect detection module 1118 may be configured to perform the steps discussed above in conjunction with step 206.

In one embodiment, the drift analysis module 1120 may be configured to estimate changes in an output of the trained machine learning model and a distribution of features associated with the object based on the labelled dataset, the model of the object, and the one or more captured images. Further, the analysis module 1120 may be configured to predict, based on one of a time series analysis and extrapolation, a time stamp when the changes in the output of the trained machine learning model and the distribution of features associated with the object would be greater than a predefined threshold. Specifically, the drift analysis module 1120 may be configured to perform the steps discussed above in conjunction with step 304 and/or 306.

In one embodiment, the image generation module 1122 may be configured to generating one or more images based on the one or more parameters associated with the imaging capturing conditions and the one or more defects applied on the model of the object. In one embodiment, the image generation module may be configured to generate one or more new images based on the one or more parameters associated with the imaging capturing conditions and the model of the object. Specifically, the image generation module 1122 may be configured to perform the steps discussed above in conjunction with step 208 and/or 310.

In one embodiment, the testing module 1124 may be configured to testing the trained machine learning model using the generated one or more images. Specifically, the testing module 1124 may be configured to perform the steps discussed above in conjunction with step 210 and/or 312.

In one embodiment, the report generation module 1126 may be configured to estimate a robustness report for the trained machine learning model based on the testing of the machine learning model. Further, the report generation module 1126 may be configured to provide a report associated with causes of the changes in the output of the trained machine learning model based on the testing of the machine learning model. Further, the report generation module may be configured to provide at least one recommended action along with an estimated time for emergency action based on the provided report. Specifically, the report generation module 1126 may be configured to perform the steps discussed above in conjunction with step 212, 314, and/or 316.

Additionally, based on implementation of the proposed method for offline robustness estimation and online monitoring of performance of trained machine learning model, the results demonstrate that there is a significant improvement in . . . visual inspection systems deployed in manufacturing lines.

To summarize, the present disclosure provides for generating synthetic data using 3D model in order to constantly test the robustness of the system and whether it needs maintenance. If a model fails in one of the areas, the disclosure facilitates highlighting which part to work on for the maintenance (i.e., replacing camera or fix camera position or adjust the lighting, etc.).

While specific language has been used to describe the present subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

We claim:

1. A method for estimating robustness of a trained machine learning model, the method comprising:
receiving a labelled dataset, a model of an object for which defect detection is required, and the trained machine learning model, wherein the trained machine learning model is used for identifying visual defects based on at least one image of the object captured in an environment around the object;
determining one or more parameters associated with image capturing conditions in the environment;
performing an auto extraction of one or more defects using the model of the object and the labelled dataset based on image processing;
generating one or more images based on the one or more parameters associated with the imaging capturing conditions and the one or more defects applied on the model of the object;
testing the trained machine learning model using the generated one or more images; and
estimating a robustness report for the machine learning model based on the testing of the machine learning model.

2. The method of claim 1, wherein the one or more parameters comprise camera intrinsic parameters, lighting, and object position.

3. The method of claim 2, wherein the camera intrinsic parameters include at least one of fstop, number of aperture blades, focal length and lens distortion parameters.

4. The method of claim 1, wherein performing the auto extraction of defective parts is based on subtracting a median image computed based on one or more samples from the labelled dataset to isolate the defect.

5. The method of claim 1, wherein the generating comprises generating the one or more images in varying conditions including associated with at least one of lighting, camera positions, dust particles, and defective flashes.

6. The method of claim 1, wherein determining the one or more parameters comprises:
dividing a search space of the one or more parameters in a predefined number of steps;
generating the one or more images to calculate a similarity score between the images from the labelled dataset and the generated images using the model of the object; and
repeating the steps of dividing and generating when the similarity score is not within a predefined threshold range.

7. The method of claim 1, wherein testing the machine learning model comprises:
determining a confidence score of the machine learning model based on testing of the machine learning model using the generated one or more images; and
determining whether the confidence score is below a predefined threshold indicating a robustness of the machine learning model; and
in response to determining that the confidence score is below the predefined threshold, re-testing the machine learning model based on a drifted version of the one or more images, wherein the drifted version is created by varying one or more parameters of the images.

8. The method of claim 1 further comprising:
determining, using the machine learning model, an amount of noise in an analysis of the one or more images during testing of the trained machine learning model, wherein the amount of noise is indicative of the noise present in an environment around the object.

9. A method for monitoring functionality of a trained machine learning model, the method comprising:
receiving a labelled dataset, a model of an object for which defect detection is required, the trained machine learning model, and one or more captured images associated with possible failure of the trained machine learning model, wherein the trained machine learning model is used for identifying visual defects in the one or more captured images of the object captured in an environment;
estimating changes in an output of the trained machine learning model and a distribution of features associated with the object based on the labelled dataset, the model of the object, and the one or more captured images;
determining one or more parameters associated with image capturing conditions in the environment;
generating one or more images based on the one or more parameters associated with the imaging capturing conditions and the model of the object;
testing the trained machine learning model using the generated one or more images; and
providing a report associated with causes of the changes in the output of the trained machine learning model based on the testing of the machine learning model.

10. The method of claim 9 further comprising:
providing at least one recommended action based on the provided report, wherein the at least one recommended action comprises one or more of modifying at least one parameter associated with the camera, modifying at least one parameter associated with lighting in the environment, and re-training the trained machine learning model.

11. The method of claim 9 further comprising:
predicting, based on one of a time series analysis and extrapolation, a time stamp when the changes in the output of the trained machine learning model and the distribution of features associated with the object would be greater than a predefined threshold,
wherein providing the report comprises the predicted time stamp when the changes would be greater than the predefined threshold.

12. The method as claimed in claim 9 further comprising:
extracting the features from the generated one or more images;
calculating the distribution of the features of the generated one or more images;
calculating one or more target features from one or more target images;
calculating a target distribution of the target features;
comparing the target distribution with respect to the distribution to calculate the changes.

13. A system for estimating robustness of a trained machine learning model, the system comprising:
at least one processor configured to:
receive a labelled dataset, a model of an object for which defect detection is required, and the trained machine learning model, wherein the trained machine learning model is used for identifying visual defects based on at least one image of the object captured in an environment around the object;
determine one or more parameters associated with image capturing conditions in the environment;
perform an auto extraction of one or more defects using the model of the object and the labelled dataset based on image processing;
generate one or more images based on the one or more parameters associated with the imaging capturing conditions and the one or more defects applied on the model of the object;
test the trained machine learning model using the generated one or more images; and
estimate a robustness report for the machine learning model based on the testing of the machine learning model.

14. The system of claim 13, wherein to perform the auto extraction of defective parts, the at least one controller is configured to perform the auto extraction of defective parts based on subtracting a median image computed based on one or more samples from the labelled dataset to isolate the defect.

15. The system of claim 13, wherein to generate the one or more images, the at least one controller is configured to generate the one or more images in varying conditions including associated with at least one of lighting, camera positions, dust particles, and defective flashes.

16. The system of claim 13, wherein to determine the one or more parameters, the at least one controller is configured to:
divide a search space of the one or more parameters in a predefined number of steps;
generate the one or more images to calculate a similarity score between the images from the labelled dataset and the generated images using the model of the object; and
repeat the steps of dividing and generating when the similarity score is not within a predefined threshold range.

17. The system of claim 13, wherein to test the machine learning model, the at least one controller is configured to:
determine a confidence score of the machine learning model based on testing of the machine learning model using the generated one or more images; and
determine whether the confidence score is below a predefined threshold indicating a robustness of the machine learning model; and
in response to a determination that the confidence score is below the predefined threshold, re-test the machine learning model based on a drifted version of the one or more images, wherein the drifted version is created by varying one or more parameters of the images.

18. The system of claim 13, wherein the at least one controller is configured to:
determine, using the machine learning model, an amount of noise in an analysis of the one or more images during testing of the machine learning model, wherein the amount of noise is indicative of the noise present in an environment around the object.

19. A system for monitoring functionality of a trained machine learning model, the system comprising:
at least one controller configured to:
receive a labelled dataset, a model of an object for which defect detection is required, the trained machine learning model, and one or more captured images associated with possible failure of the trained machine learning model, wherein the trained machine learning model is used for identifying visual defects in the one or more captured images of the object captured in an environment;
estimate changes in an output of the trained machine learning model and a distribution of features associated with the object based on the labelled dataset, the model of the object, and the one or more captured images;
determine one or more parameters associated with image capturing conditions in the environment;
generate one or more images based on the one or more parameters associated with the imaging capturing conditions and the model of the object;
test the trained machine learning model using the generated one or more images; and
provide a report associated with causes of the changes in the output of the trained machine learning model based on the testing of the machine learning model.

20. The system of claim 19, wherein the at least one controller is configured to:
provide at least one recommended action based on the provided report, wherein the at least one recommended action comprises one or more of modifying at least one parameter associated with the camera, modifying at least one parameter associated with lighting in the environment, and re-training the trained machine learning model.

21. The system of claim 19, wherein the at least one controller is configured to:
predict, based on one of a time series analysis and extrapolation, a time stamp when the changes in the output of the trained machine learning model and the distribution of features associated with the object would be greater than a predefined threshold,
wherein to provide the report, the at least one controller is configured to provide the predicted time stamp when the changes would be greater than the predefined threshold.

22. The system as claimed in claim 19, wherein the at least one controller is configured to:
extract the features from the generated one or more images;
calculate the distribution of the features of the generated one or more images;
calculate one or more target features from one or more target images;
calculate a target distribution of the target features; and
compare the target distribution with respect to the distribution to calculate the changes.
